(19) United States
(12) Patent Application Publication
(10) Pub. No.: US 2012/0080049 A1
(43) Pub. Date: Apr. 5, 2012

(54) Dental Floss Pick

(76) Inventor: En-Heng Liu, Taipei City (TW)

(21) Appl. No.: 12/895,911

(22) Filed: Oct. 1, 2010

(51) Int. Cl. A61C 15/04

(52) U.S. Cl. 132/323

(57) ABSTRACT

A dental floss pick is composed of a frame, a floss and a grip portion, wherein the frame has a first section and a second section. The first section extends from one end of the frame to a predetermined range and the second section extends from the first section to connect one end of the grip portion. Because the first section defines a first tooth-accommodating area with a height, which is smaller than a distance between the occlusal surface and the interdental papilliae, therefore, when a user places the floss into the slits between the teeth, the floss is limited in depth by the first tooth-accommodating area to avoid damaging the gum. Moreover, the floss is modified into two sections with different materials and shapes for cleaning different teeth slits at different location and characteristics to improve the cleaning convenience and avoid gun injury.

### BACKGROUND OF THE INVENTION

1.Field of the Invention

The present invention relates to a dental floss pick, and more particular to a dental floss pick that avoids the gum injury and hurt to the users and provides sufficient and convenient cleaning products for tooth slits of different locations and tightness in the oral cavity.

2. Description of Related Art

Oral hygiene influences not only the body health but also personal image and social activity. People will feel embarrassed when talk to friends or clients if the food residue stuck in the tooth slits after feast. In Taiwan or other Asia countries, people use sharp thin distal ends of bamboo picks to push the food residue out from the tooth slits. However, this operation removes the food residue incompletely but also widens the tooth slits or injures the gum so that the gum might be shrunk by infection. In western restaurant, the toothpick is not provided usually. People often carry floss box and clean the tooth slits by entering a section of pulled straight floss winding on two fingers into the oral cavity. This operation is inconvenient and is easy to cause oral infection when the fingers are not sterilized completely. Disposable plastic dental pick is the most acceptable tools for cleaning tooth slits because of the easy operation and portability. However, the floss on the disposable plastic dental pick is made of polyester filament, which splits easily or gets stuck in the tight tooth slits. Moreover, two distal ends holding the floss usually bump the gum and thus cause the gum bleeding, pain or even infection.

### SUMMARY OF THE INVENTION

A main objective of the present invention is to provide a dental floss pick that avoids the gum injury and hurt to the users and provides sufficient and convenient cleaning products for tooth slits of different locations and tightness in the oral cavity.

To achieve the foregoing objective, the dental floss pick comprises:
a frame formed on one end of the dental floss pick, the frame comprising:
   a first section extending from one end of the frame to a predetermined range and defining a first tooth-accommodating area; and
   a second section extending from the first section and defining a second tooth-accommodating area which is larger than the first tooth-accommodating area; and
a floss secured on the frame, made of at least one material and divided into a first part within the first tooth-accommodating area of the frame and a second part within the second tooth-accommodating area of the frame.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a dental floss pick in accordance with the present invention;

FIG. 2 is a partially exploded perspective view of the dental floss pick in accordance with the present invention;

FIG. 3 is an operational cross-sectional view of the dental floss pick applied to clean tooth slits;

FIG. 4 is an operational side view of the dental floss pick applied to clean tooth slits;

FIG. 5 is a perspective view of the dental floss pick with a partial enlarged joint portion;

FIG. 6 is a perspective view of the dental floss pick with a partial enlarged floss;

FIG. 7 is another operational perspective view of the dental floss pick; and

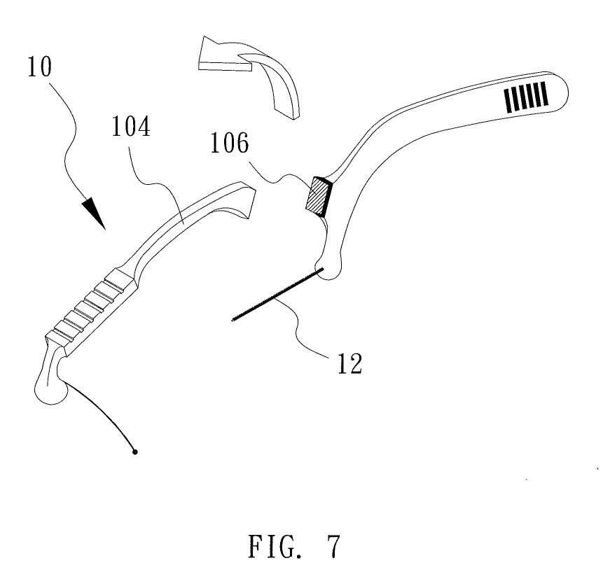

FIG. 8 is another operational cross-sectional view of the dental floss pick applied to clean tooth slits.

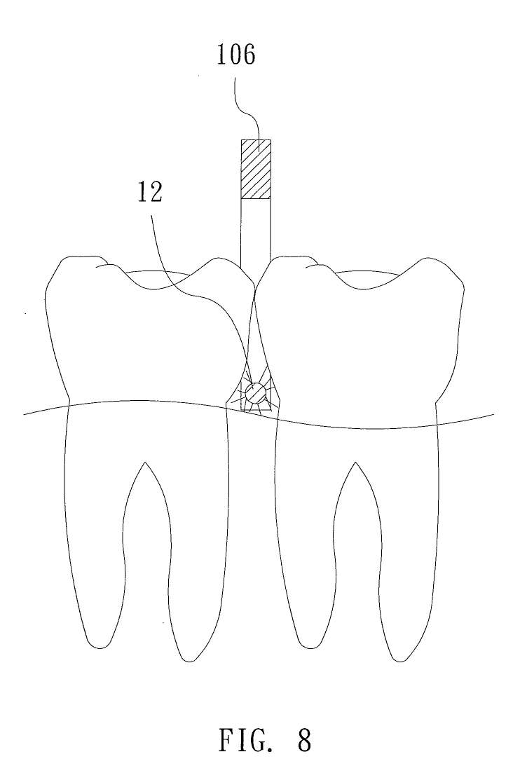

### DETAILED DESCRIPTION OF THE PREFERRED EMBODIMENT

A dental floss pick in the present invention is composed of a frame, a floss and a grip portion, wherein the frame has a first section and a second section. The first section extends from one end of the frame to a predetermined range and the second section extends from the first section to connect to the grip portion. Because the first section defines a first tooth-accommodating area with a height, which is smaller than a distance between the occlusal surface and the interdental papilliae, therefore, when a user places the floss into the slits between the teeth, the floss is limited in depth by the first tooth-accommodating area to avoid damaging the gum. Moreover, the floss is modified into two-section structure with different materials and shapes for cleaning different teeth slits of different locations and characteristics to improve the cleaning convenience and to avoid gun injury.

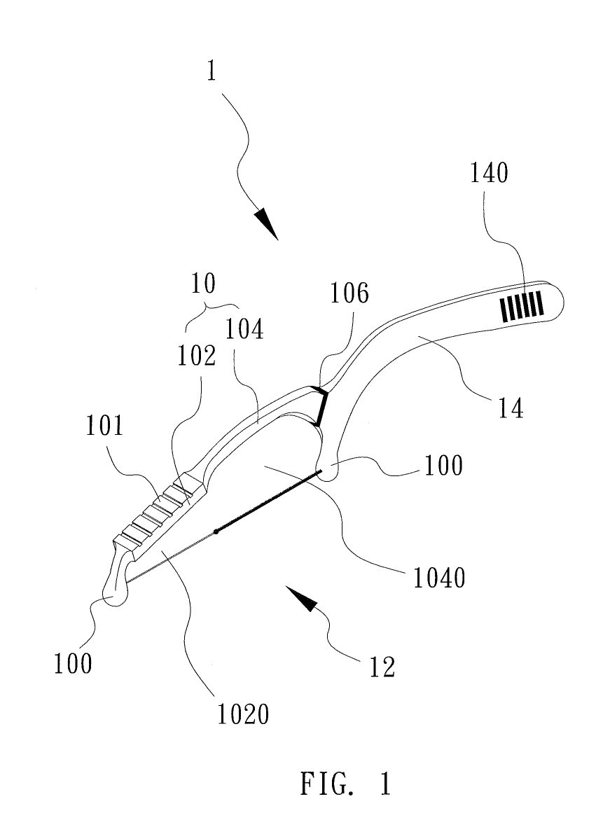

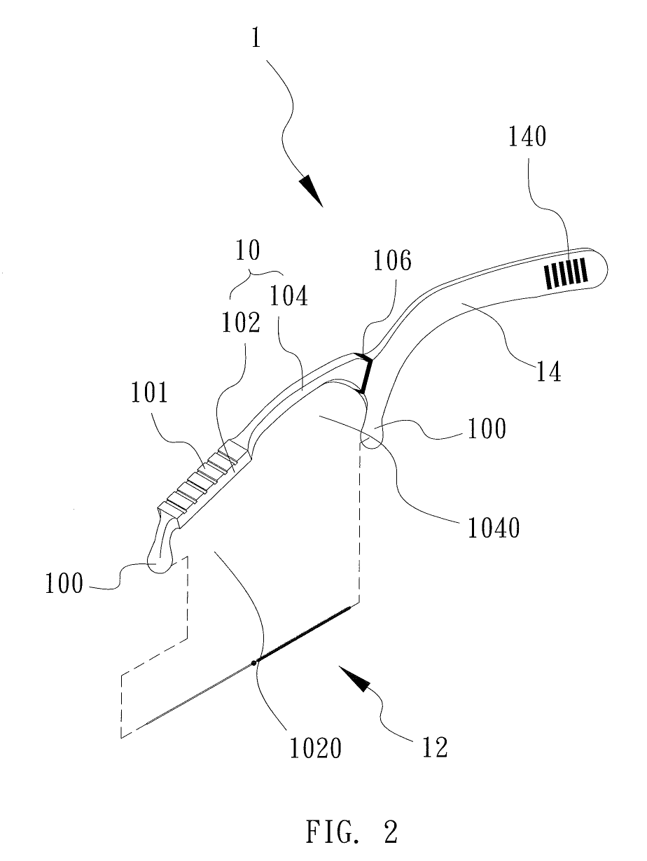

As shown in FIGS. 1 and 2, a preferred embodiment of a dental floss pick 1 in accordance with the present invention comprises a frame 10, a floss 12 and a grip section 14. The frame 10 has two balls ends 100 oppositely formed thereon to secure the floss 12, wherein the frame 10 has a first section 102 and a second section 104. The first section 102 has a predetermined range to allow teeth moving therein and the second section 104 extends from the first section 102 to connect to one end of the grip section 14. Because the first section 102 defines a first tooth-accommodating area 1020 with a height which is smaller than a height of a second tooth-accommodating area 1040 within the second section 104, therefore, when a user places the floss 12 into the slits between the teeth, the floss 12 is limited in depth by the first tooth-accommodating area 1020 to avoid damaging the gum.

Moreover, the floss 12 is made of different materials in parts. A part of the floss 12 within the first section 102 has a flat and smooth structure and another part of the floss 12 within the second section 104 has a brush structure. A concave portion 106 is defined on the frame at a predetermined location. Thereby, the dental floss pick 1 enables to clean tooth slits at different locations. The dental floss pick 1 has a grip section 14 formed to extend in opposite direction relative to the frame 10. The grip section 14 is designed into a tapered shape or an arc shape and further has an anti-slip portion 140 to enhance the holding texture by the user. The first section 102 has an outer surface made by a tooth pad 101.

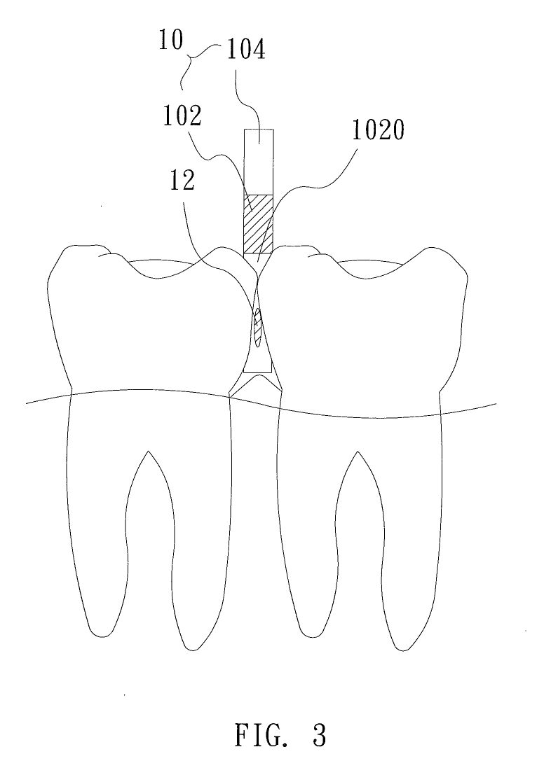

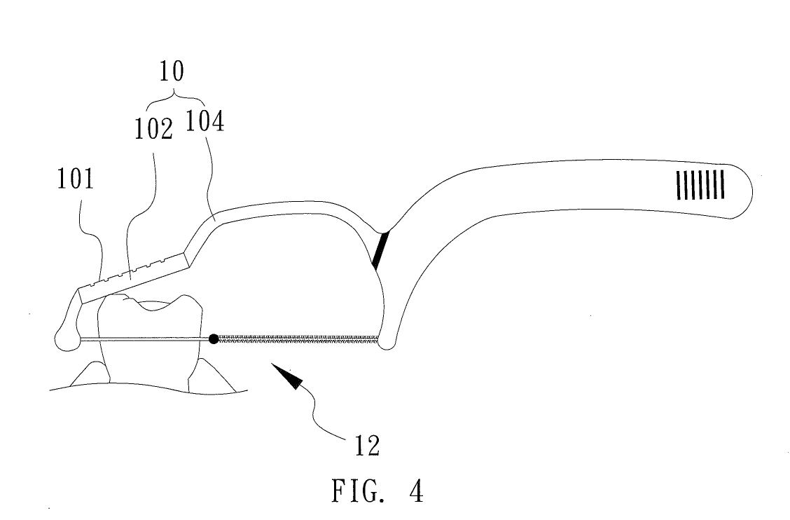

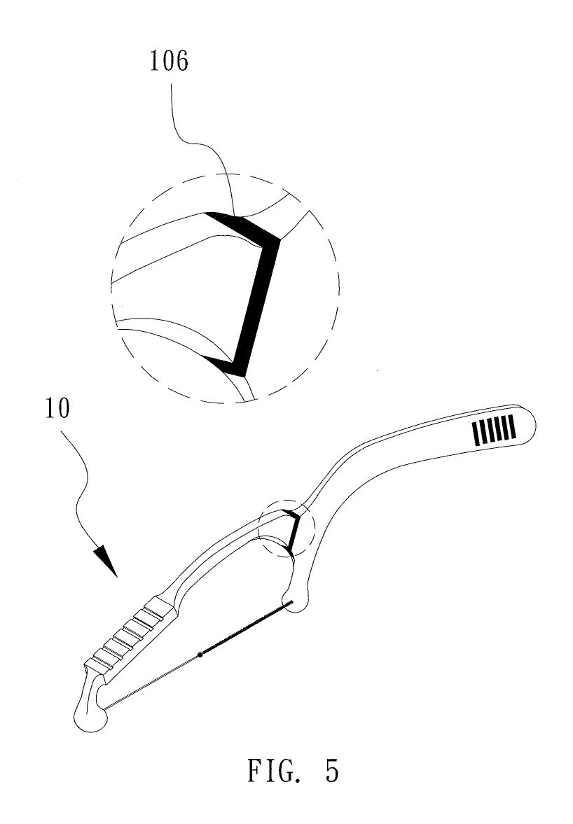

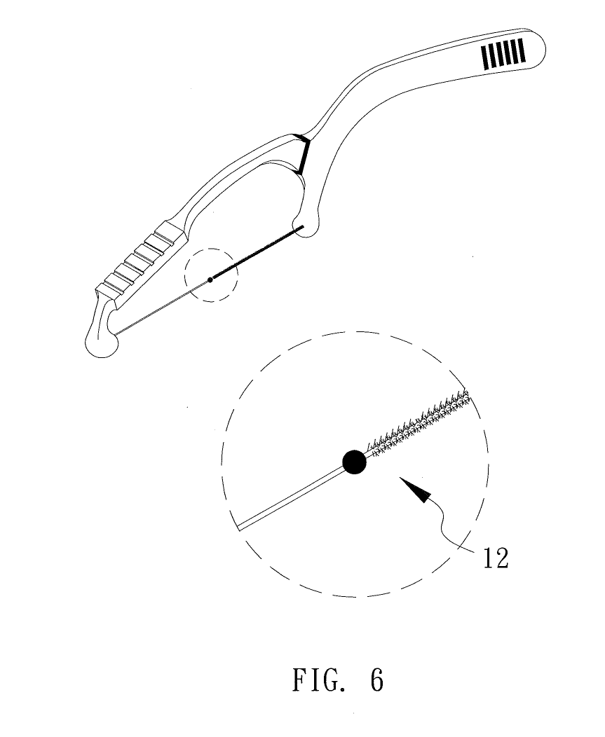

According to above-mentioned structure, the operation of the dental floss pick in the present invention is shown in FIGS. 3-6. When the floss 12 enters a tooth slit, the tooth crown is within the first tooth-accommodating area 1020 of the frame 10. However, the first tooth-accommodating area 1020 cannot accommodate the whole length of the tooth so that the floss cannot touch the gum because the top of the teeth already abuts an inner side of the frame 10. Therefore, a user has no worry about rubbing the gum with the floss 12 and causing damage or bleeding when pushing the floss 12 too hard into the tooth slit. Moreover, the outer surface of the first section 102 is a tooth pad 101. When using the dental floss pick, the user makes the teeth to abut the tooth pad 101 and meanwhile the floss 12 aligns to the slit. Then, when the user bites the tooth pad 101, the floss 12 is driven to enter the slit. By biting and stopped by the tooth pad 101, the floss 12 will not go into the slit with over depth and thus the gum damage is avoided. The pushing force to make the floss to enter the tooth slit is well controlled.

The height of the first section 102 has a height limitation (about 5 mm) smaller than a height of the second section 104. By blocking the over pushing of the floss 12 with the first section 102, the floss 12 does not injure the gum between two adjacent teeth (the interdental papilliae) when being pushed to enter the tooth slit without controlling force well. Because the average height between the occlusal surface and the gum in the tooth slit (the interdental papilliae) is about 6-7 mm, the narrowed design of the first section 102 provides protective efficiency to gum. The height of the second section 104 has an enlarged width (about 10 mm) to allow user has sufficient space and a wide angle to slip the floss 12 inside the tooth slit forward or backward to remove the food residues stuck therein.

When cleaning slits between molar teeth or under a fixed partial denture, the user optionally and easily breaks the concave portion 106 formed on the second section 104 defined on the frame 10 because the concave portion 106 has a thin thickness, meanwhile, one section of the frame 10 is disengaged and the floss 12 is cut into multiple parts, two parts for example in this preferred embodiment. Because the floss 12 is made of different materials (two different materials are shown in this embodiment), when the user cleans the slits of molar teeth or the fixed partial denture with the rigid material in form of brush structure by moving the cut floss 12 forward and backward, but not by moving a conventional dental floss upward and downward. By having above structure, the dental floss pick improves its utility and provides different cleaning means to apply to various habits of different users.

The above-mentioned floss 12 is designed into two sections with different materials and shapes, wherein the first part of the floss 12 (the flat and smooth structure) within the first section 102 is used for slipping the floss 12 into the slits between two adjacent teeth and thus is selectively made of polytetrafluoroethylene (PTFE). Moreover, for any narrow slits between two adjacent teeth, the first part of the floss 12 is applied thereto. The second part of the floss 12 (the brush structure) within the second section 104 is designed to be porous (or with more surface area) and have cross-sectional diameter of 1 mm. By horizontally moving the second part of the floss 12 forward or backward, food residue or Adhesive plaque on adjacent surfaces of teeth is completely removed. The second part of the floss 12 is made of nylon steel brush or porous non-woven strips. Moreover, for any wide slits between two adjacent teeth, the second part of the floss 12 is applied to clean.

Although this invention has been described in its preferred form with a certain degree of particularity, it is understood that the present invention of the preferred form has been made only by way of example and that numerous changes in the details of construction and the combination and arrangement of parts any be resorted to without departing from the spirit and scope of the invention.

What is claimed is:

1. A dental floss pick comprising:
a frame formed on one end of the dental floss pick, the frame comprising:
a first section extending from one end of the frame to a predetermined range allowing teeth moving inside and defining a first tooth-accommodating area; and
a second section extending from the first section to connect to a grip section and defining a second tooth-accommodating area which is larger than the first tooth-accommodating area; and
a floss secured on the frame, made of at least one material and divided into a first part within the first tooth-accommodating area of the frame and a second part within the second tooth-accommodating area of the frame.

2. The dental floss pick as claimed in claim 1, wherein the frame has a concave portion defined at a predetermined location on the frame.

3. The dental floss pick as claimed in claim 1, wherein the first part of the floss is in form of flat and smooth structure and the second part of the floss is in form of brush structure.

4. The dental floss pick as claimed in claim 1, wherein the first section of the frame has an outer surface made by a tooth pad.

5. The dental floss pick as claimed in claim 1, wherein the frame has two balls ends oppositely formed on two ends of the frame to secure the floss.

6. The dental floss pick as claimed in claim 1, wherein the grip section is in form or thin sharp structure or arc structure.

7. The dental floss pick as claimed in claim 1, wherein the grip section further has an anti-slip portion.
